(19) United States
(12) Patent Application Publication
(10) Pub. No.: US 2010/0162476 A1
(43) Pub. Date: Jul. 1, 2010

(54) BRAKING DEVICE INTERPOSABLE BETWEEN MOTUALLY ROTATABLE ELEMENTS

(76) Inventor: Livio Cavagna, Lumezzane (IT)

Correspondence Address: Modiano & Associati, Via Meravigli, 16, Milan, IT

(21) Appl. No.: 12/451,759

(22) PCT Filed: Dec. 20, 2007
(86) PCT No.: PCT/EP2007/064381

§ 371 Date: Nov. 30, 2009

(30) Foreign Application Priority Data
Jun. 13, 2007 (IT) MI2007A001193

(51) Int. Cl. A47K 13/12; E05D 3/00

(52) U.S. Cl. 4/236; 188/67

(57) ABSTRACT

A braking device which can be interposed between mutually rotatable elements and comprises a first body, which rotates rigidly with a first element, and a second body, which rotates rigidly with a second element and can engage rotatably the first body, the device further comprising means for translational motion in order to impart a translational motion of the second body with respect to the first body upon mutual rotation, elastically deformable means being provided which interact between the first body and the second body in order to contrast the translational motion upon mutual rotation between the bodies, at least in one preset direction.

The present invention relates to a braking device interposable between mutually rotatable elements.

### BACKGROUND OF THE INVENTION

As is known, in many fields there is the need to have braking elements which brake the relative movement between two elements in one direction of rotation but do not cause a particular hindrance for rotation in the opposite direction.

Considering, merely by way of example, the case of covers of sanitary fixtures, it is found that it is useful to be able to brake the rotation of the seat with respect to the sanitary fixture in order to prevent its accidental fall, which may constitute an element of risk and in any case may damage the cover.

Currently, in order to solve the problem, devices have already been provided which, generally speaking, are based on an oil-operated braking device in which the oil passes from one chamber to the other in order to slow the descent.

Such embodiment, besides being very complicated from a manufacturing standpoint, is not particularly functional, since it allows rotations at the most of approximately 110°, and therefore forcing, with consequent breakage, is not infrequent.

### SUMMARY OF THE INVENTION

The aim of the invention is to solve the problems described above by providing a braking device interposable between mutually rotatable elements which allows to apply a braking action which is particularly effective though using elements which are structurally very simple.

Within this aim, an object of the invention is to provide a braking device in which the structure itself is in practice capable of increasing the braking action by rotation in a preset direction, thus compensating the increase in moment which occurs for example in case of connection of the covering element to a sanitary fixture in the final portion of the descent.

Another object of the present invention is to provide a braking device which, thanks to its particular constructive characteristics, is capable of giving the greatest assurances of reliability and safety in use.

Still another object of the present invention is to provide a braking device which can be obtained easily starting from commonly commercially available elements and materials and is also competitive from a merely economical standpoint.

This aim and these and other objects, which will become better apparent hereinafter, are achieved by a braking device which can be interposed between mutually rotatable elements, according to the invention, comprising a first body, which rotates rigidly with a first element, and a second body, which rotates rigidly with a second element and can engage rotatably said first body, characterized in that it comprises means for translational motion in order to impart a translational motion of said second body with respect to said first body upon mutual rotation, elastically deformable means being further provided which interact between said first body and said second body in order to contrast said translational motion upon mutual rotation between said bodies, at least in one preset direction.

### BRIEF DESCRIPTION OF THE DRAWINGS

Further characteristics and advantages of the present invention will become better apparent from the description of some preferred but not exclusive embodiments of a braking device interposable between mutually rotatable elements, illustrated by way of non-limiting example in the accompanying drawings, wherein:

FIG. 1 is a perspective view of the device, in a first embodiment, with a ring provided with holes;

FIG. 2 is a partially sectional elevation view of the device, with the first element in a first working position;

FIG. 3 is a partially sectional elevation view of the device, with the second element in a second working position;

FIG. 4 is a sectional view, taken along the line IV-IV of FIG. 2;

FIG. 5 is a sectional view, taken along the line V-V of FIG. 2;

FIG. 6 is a sectional view, taken along the line VI-VI of FIG. 2;

FIG. 7 is an exploded perspective view of a second embodiment, with a ring provided with perimetric protrusions;

FIG. 8 is a partially sectional front view of the embodiment of FIG. 7;

FIG. 9 is a sectional view, taken along the line IX-IX of FIG. 8;

FIG. 10 is an exploded perspective view of further embodiment of the device, with a ring provided with a circumferential protrusion;

FIG. 11 is a sectional elevation view of the embodiment of FIG. 10;

FIG. 12 is a sectional view, taken along the line XII-XII of FIG. 11;

FIG. 13 is a perspective view of still a further embodiment of the device, with the elastically deformable means having a contoured shape;

FIG. 14 is a sectional elevation view of the embodiment of FIG. 13;

FIG. 15 is a sectional view, taken along the line XV-XV of FIG. 14;

FIG. 16 is a perspective view of a further embodiment, with a ring provided with a perimetric groove;

FIG. 17 is a sectional elevation view of the embodiment of FIG. 16;

FIG. 18 is a sectional view, taken along the line XVIII-XVIII of FIG. 17;

FIG. 19 is a perspective view of an embodiment with the ring connected to the second body;

FIG. 20 is a partially sectional elevation view of the embodiment of FIG. 19;

FIG. 21 is a sectional view, taken along the line XXI-XXI of FIG. 20;

FIG. 22 is an exploded perspective view of an embodiment with a ring with perimetric protrusions which is rigidly coupled to the second body;

FIG. 23 is a partially sectional elevation view of the embodiment of FIG. 22;

FIG. 24 is a sectional view, taken along the line XXIV-XXIV of FIG. 23;

FIG. 25 is an exploded perspective view of the device with a different type of coupling;

FIG. 26 is a partially sectional elevation view of the embodiment of FIG. 25;

FIG. 27 is an exploded perspective view of the device with a fixed hook;

FIG. 28 is a partially sectional elevation view of the embodiment of FIG. 27;

FIGS. 29 and 30 are respectively an exploded perspective view and a sectional view of a further embodiment of the means for translational motion;

FIG. 31 is a view of an embodiment in which the threads are kinematically reversed with respect to the embodiment of FIGS. 29 and 30;

FIG. 32 is an exploded perspective view of a braking device which can be interposed between a first body and a second body having any shape;

FIG. 33 is a view of a further embodiment with a fixed hook.

### DESCRIPTION OF THE PREFERRED EMBODIMENTS

With reference to the figures, the braking device interposable between mutually rotatable elements can be applied in different working solutions in which it is necessary to provide mutual braking between two mutually movable elements; in the description, for the sake of simplicity, a typical embodiment for connecting the cover to a sanitary fixture is shown.

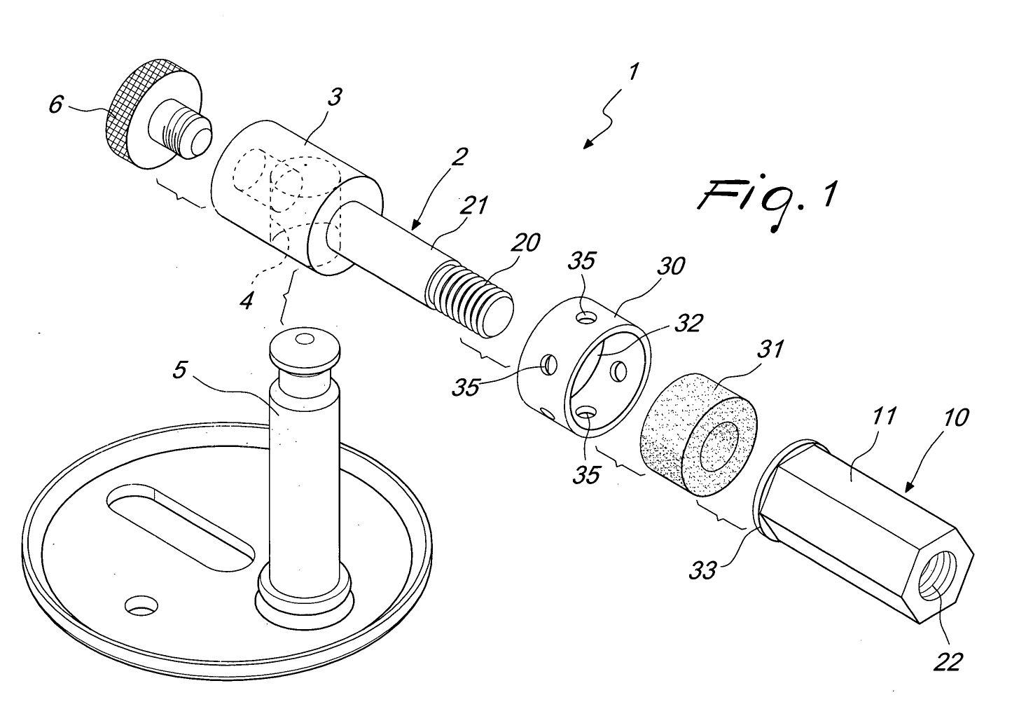

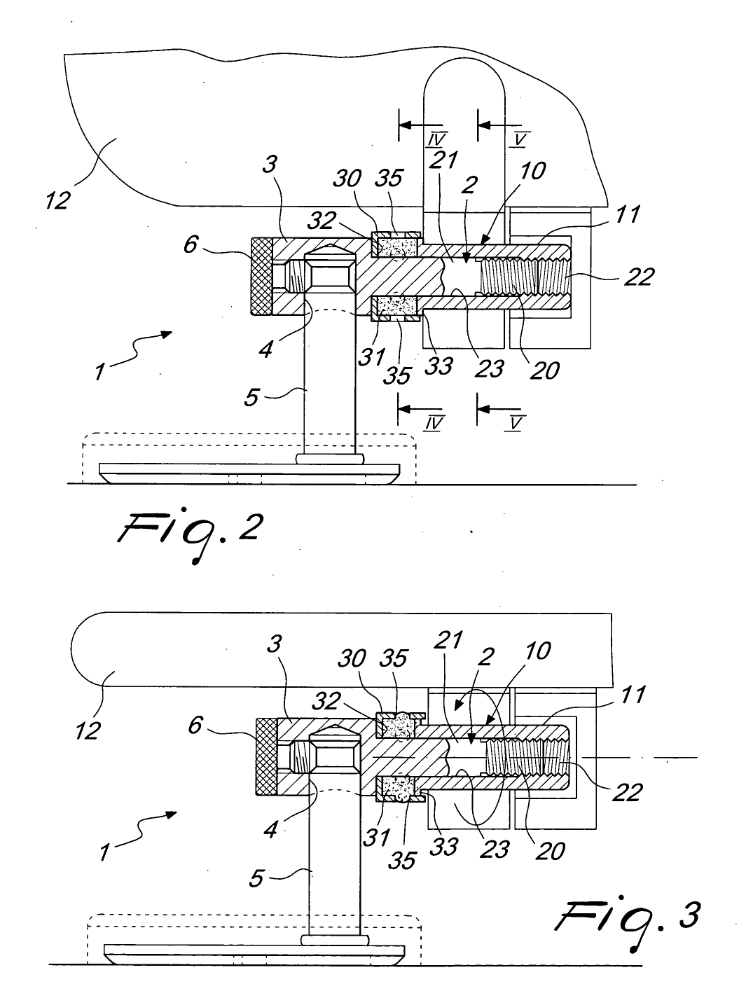

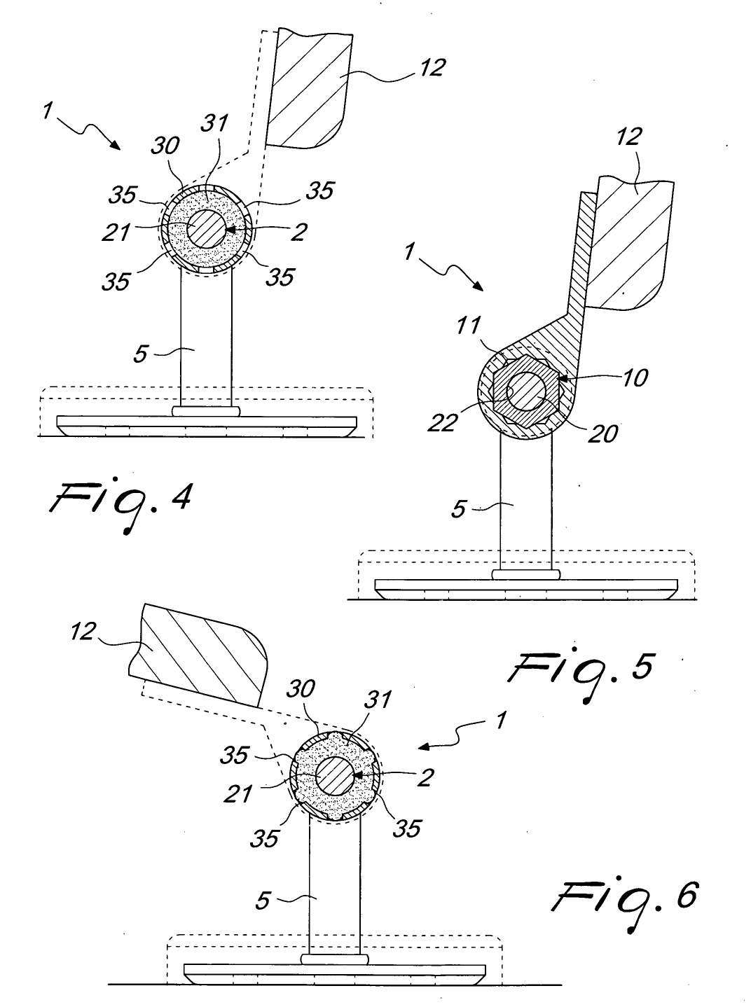

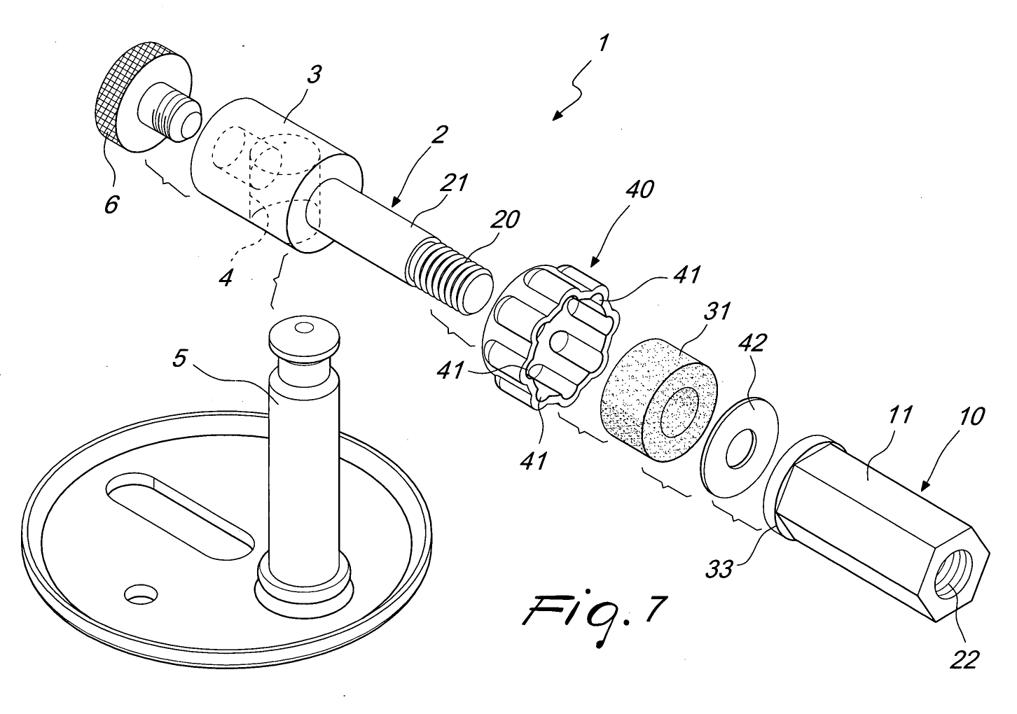

In the embodiment described in FIGS. 1 to 6, the device, generally designated by the reference numeral 1, comprises a first body 2, connected to a coupling body 3 which defines a seat 4 in which it is possible to insert the contoured head of a post 5 which can be fixed to a sanitary fixture.

The coupling body 3 is rigidly coupled by means of a pawl 6, which is inserted in the seat 4 so as to make its active end clamp against the head of the post 5, thus coupling the first body 2 with respect to the first element, which is constituted for example by the sanitary fixture.

A second body 10 engages the first body 2 and is constituted advantageously by a bush 11, whose outer cross-section is contoured so as to rotate rigidly with a second element, constituted for example by the seat 12 of a seat cover; in the specific example, the bush 11 is hexagonal.

The first body 2 and the second body 10 are coupled to each other by way of means for translational motion, which in practice force a translational motion of the second body when a mutual rotation occurs between the first body and the second body.

In the specific case, such means for translational motion are provided by means of a threaded portion 20, which is defined at the end of a stem 21 which defines the first body 2 and engages a threaded seat 22 defined at the end of a cavity 23 provided by the bush 11.

The characterizing feature is constituted by the fact that there are elastically deformable means which interact between the first body and the second body and are positioned in a containment region.

In a first embodiment, illustrated in the drawings from FIG. 1 to FIG. 6, the containment region is defined by a ring 30, which can be accommodated on the device 1 which contains the elastically deformable means constituted by a body 31 made of elastically deformable material which is positioned between a base flange 32 of the ring 30 and a front flange 33 which is defined by the bush 11, so that when the second body 10 rotates with respect to the first body 2, an axial compression occurs on the body made of elastically deformable material 31 which, in a way, contrasts movement in an axial direction, which consequently slows the rotation between the body 10 and the body 2 in the direction in which mutual rotation causes compression of the elastically deformable body.

In order to allow the elastic deformation of the elastically deformable body 31, it is necessary to provide expansion regions which allow such body to assume a contraction in an axial direction, and in the specific example such expansion regions are provided by means of openings or holes 35 which are defined on the side wall of the ring 30 or by spaces which are free from the elastically deformable body in the containment region.

With this arrangement, when rotation occurs, constituted for example by the lowering of the seat onto the sanitary fixture, the bush 11, by rotating, takes, due to the mating between the threaded portion 20 and the threaded seat 22, a component which pushes axially the deformable body, which somehow, during the axial compression step, contrasts this movement and provides a brake against rotation.

The presence of the expansion regions constituted by the peripheral holes 35 allows the elastically deformable body 31 to expand radially, consequently compressing itself radially.

With this arrangement, therefore, the descent of the seat onto the sanitary fixture undergoes a braking action, which increases progressively as compression in an axial direction occurs on the deformable body 31.

Advantageously, in the case of the coupling of a covering element to a sanitary fixture, the braking device is applied at both connecting pins and it is consequently necessary to provide couplings with mutually opposite threads so as to achieve compression of the deformable body on both sides.

Moreover, the braking element can act at the seat, at one post, and can act at the lid of the covering element at the other post.

It should be added to what has been described above that by increasing the precompression of the elastically deformable means it is possible to achieve a retention action, so that the second element remains in any position it is released in.

With this arrangement, therefore, transition from one position to another always requires the application of a pushing action to the second element.

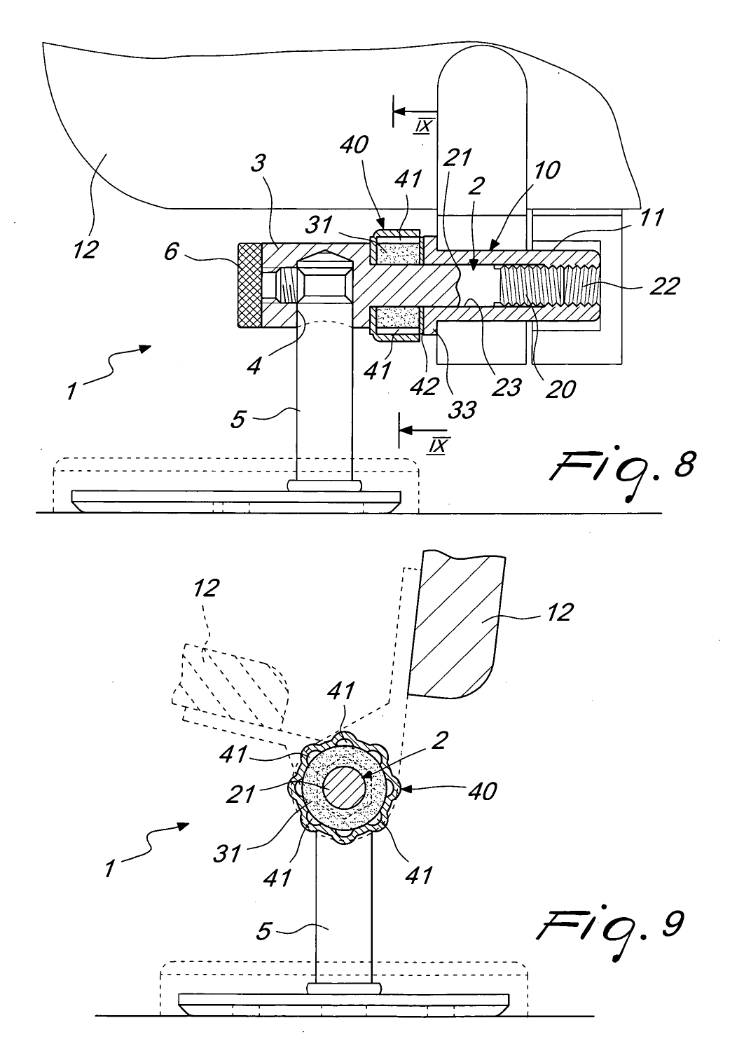

With reference to FIGS. 7 to 9, an embodiment is shown which is conceptually similar to the preceding one, with the variation that the ring, now designated by the reference numeral 40, has expansion regions which are provided by means of radial protrusions 41 which allow the outward deformation of the elastically flexible body 31 when it is compressed axially.

It is optionally also possible to provide a washer 42 which engages the axial end of the deformable body and is interposed between the deformable body and the bush 11.

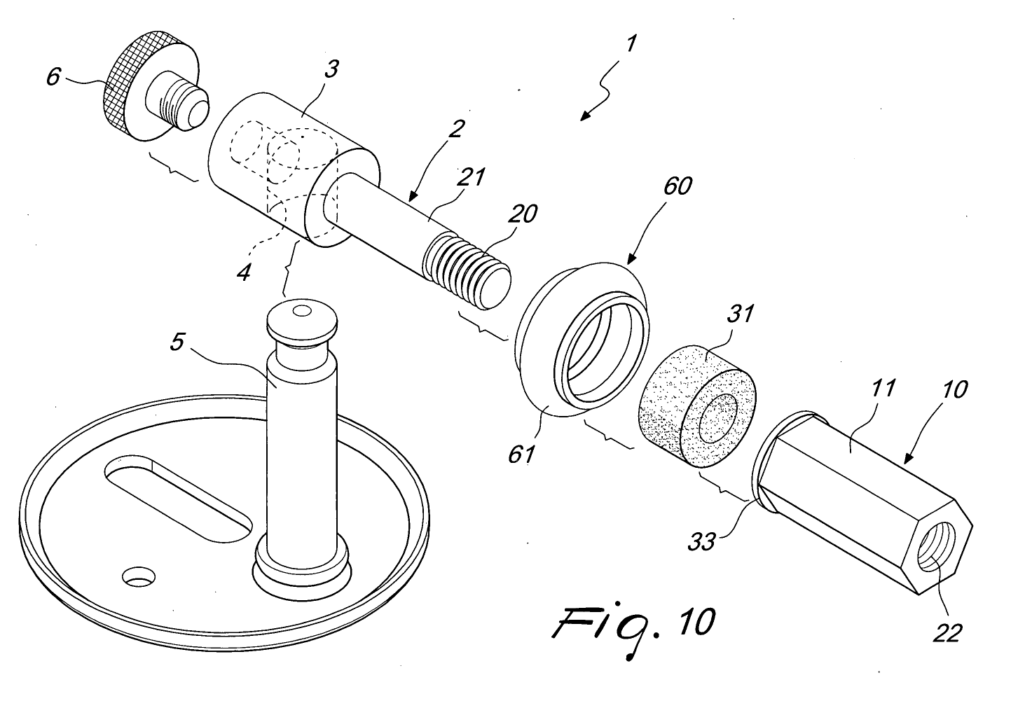

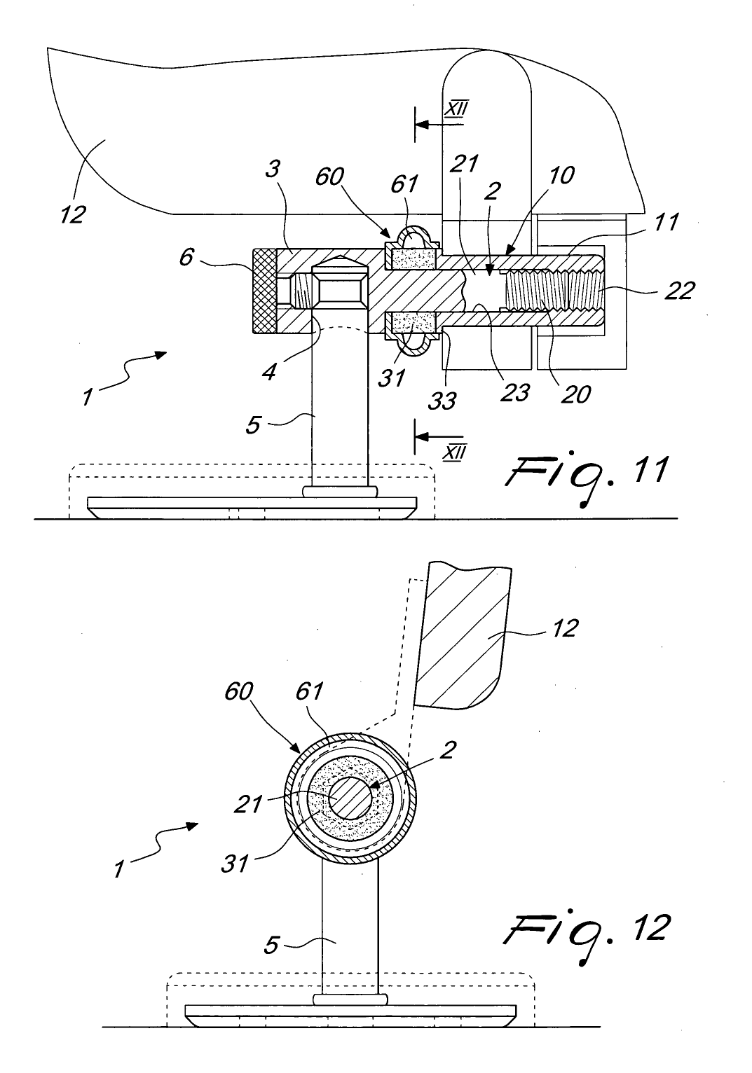

In the embodiment shown in FIGS. 10 to 12, the ring, now designated by the reference numeral 60, has a peripheral protrusion 61 which allows the elastically deformable body 31 to expand upon radial compression, so as to provide the braking action with a gradual contrast to axial movement.

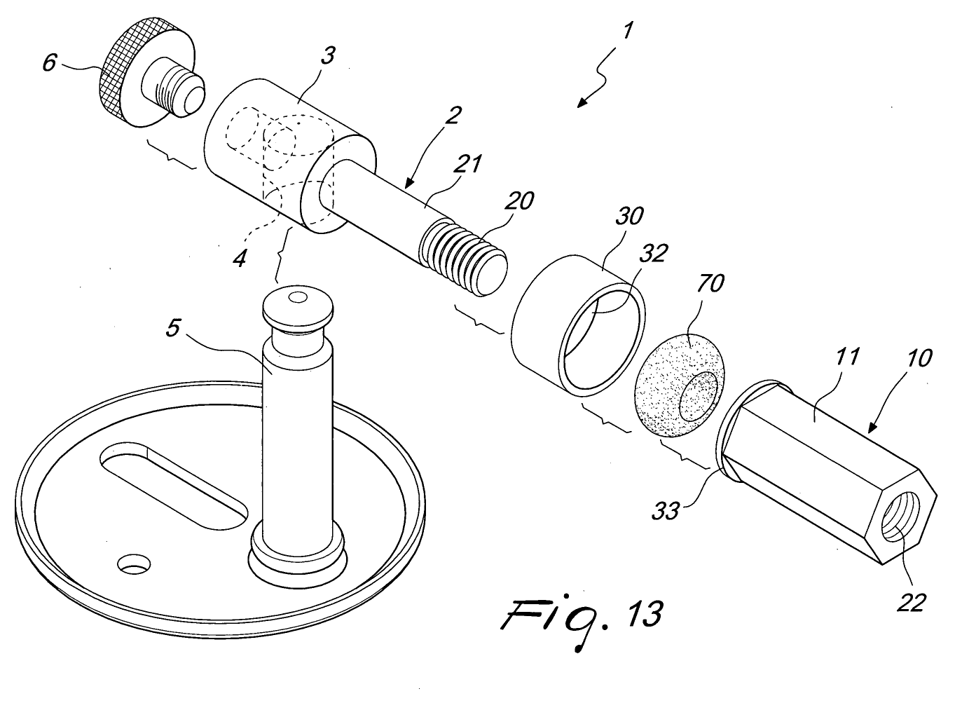

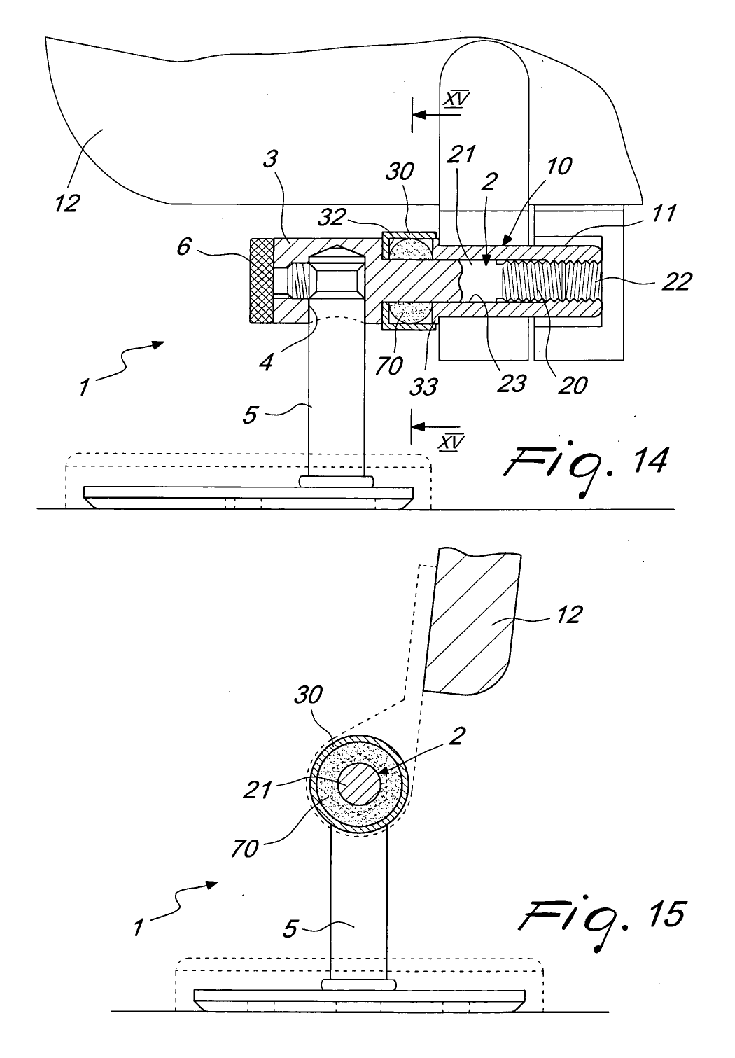

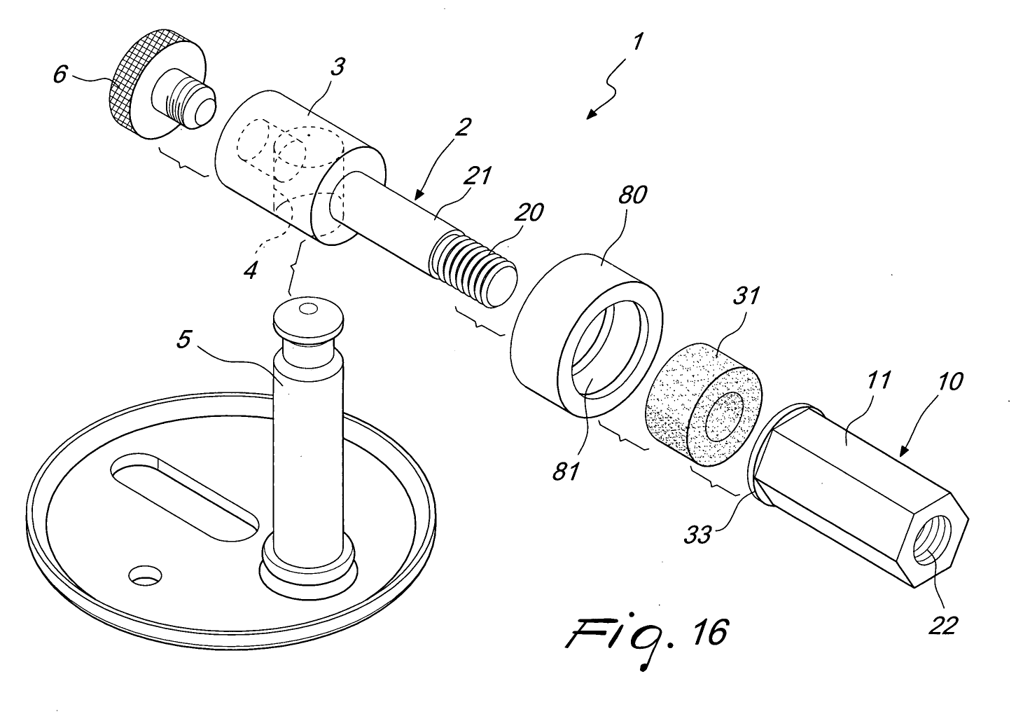

In the embodiment shown in FIGS. 13 to 15, the elastically deformable body, designated by the reference numeral 70, has a contoured shape with respect to the accommodation region defined by the ring 30, and it provides directly the expansion regions in the containment region provided by the ring 30.

In this manner, elastic deformation of the elastically deformable body 70 is made possible because upon axial compression the elastically deformable body can, in a way, fill the regions that it left empty initially.

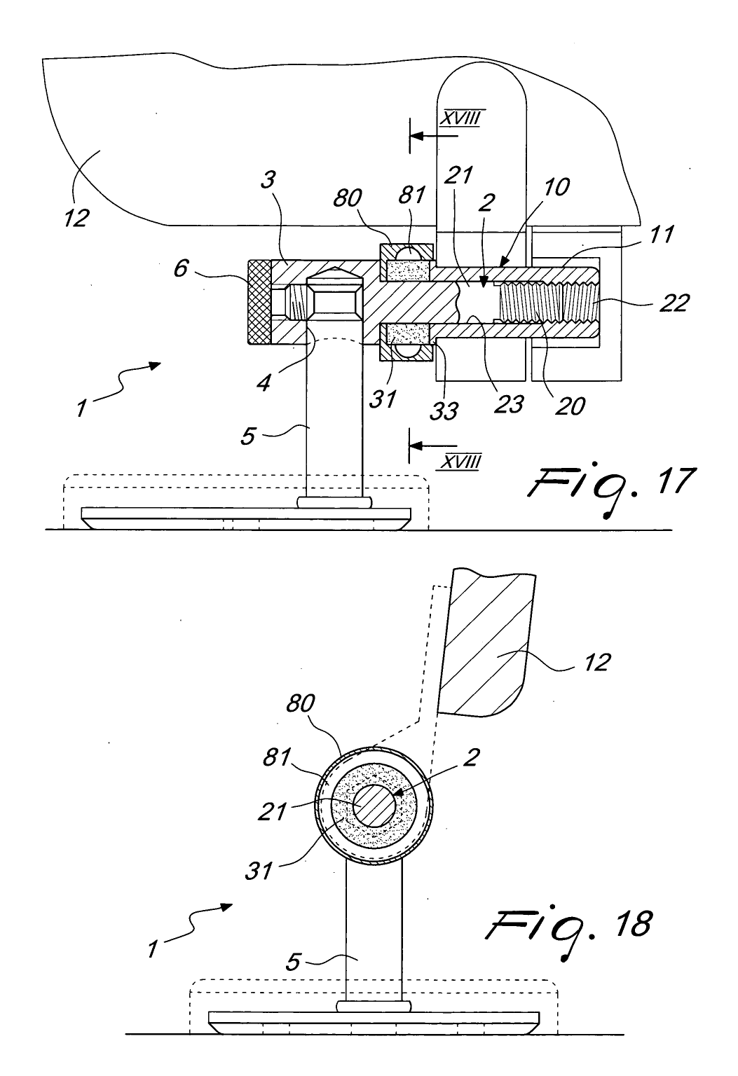

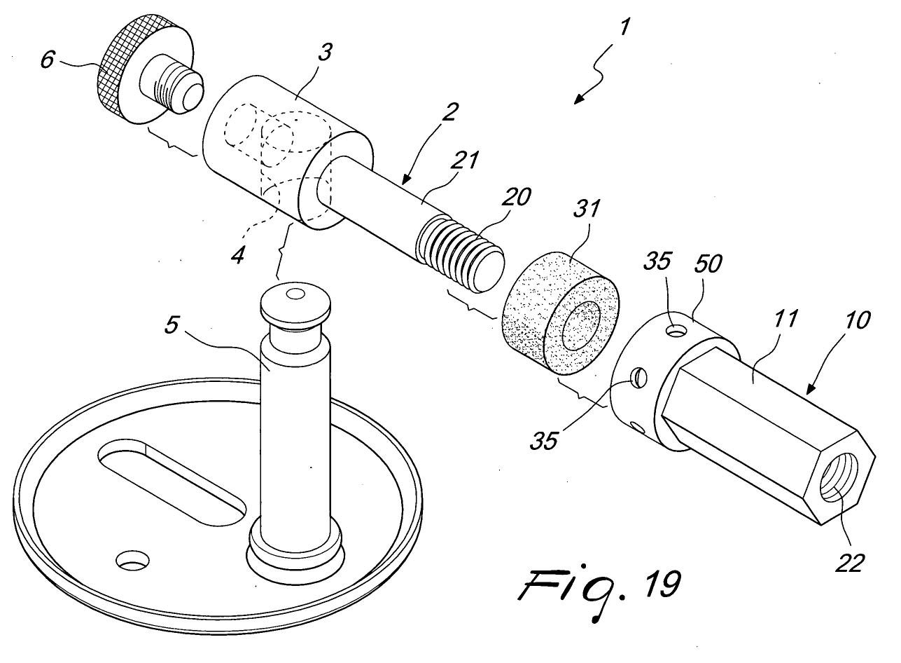

According to what is shown in FIGS. 16 to 18, there is a ring 80 with a perimetric hollow 81 which provides the expansion region for the elastically deformable body 31, which during axial compression can expand in a radial direction.

FIG. 19 illustrates an embodiment which is conceptually equivalent to the preceding ones, with the variation that a fixed ring, designated by the reference numeral 50, is provided and is connected directly to the bush 11 which provides the second body 10.

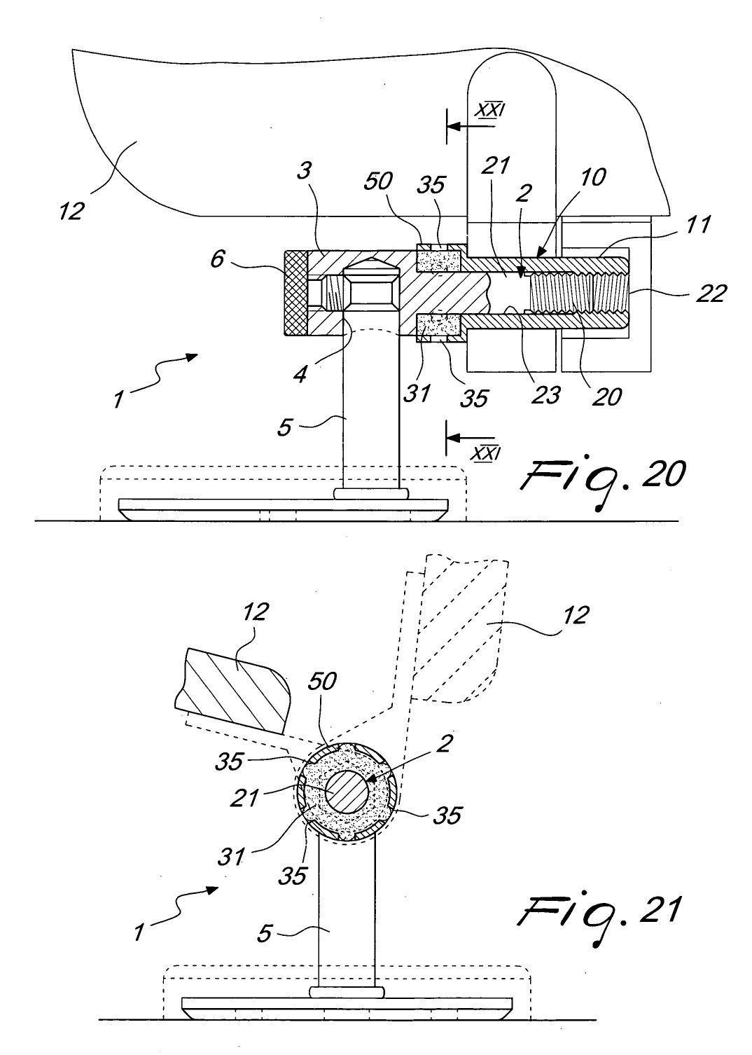

In the embodiment shown in FIGS. 19 to 21, the fixed ring 50 can have the openings 35, which are fully equivalent to those shown in the ring 30; such openings 35 can be replaced by the contoured shape of the elastically deformable body 70 or the like.

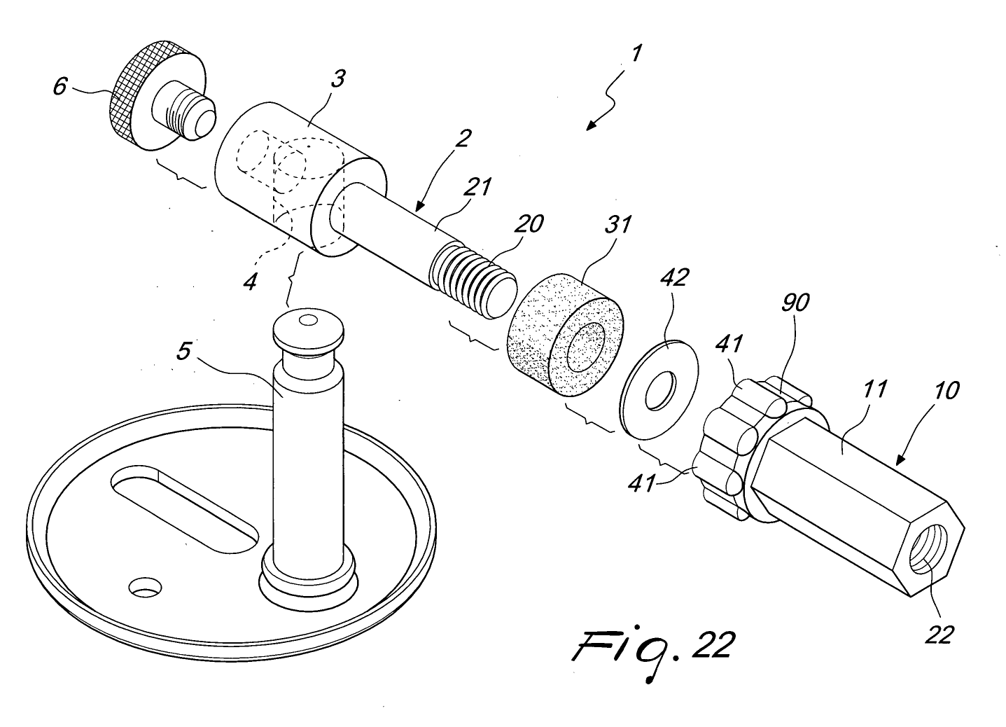

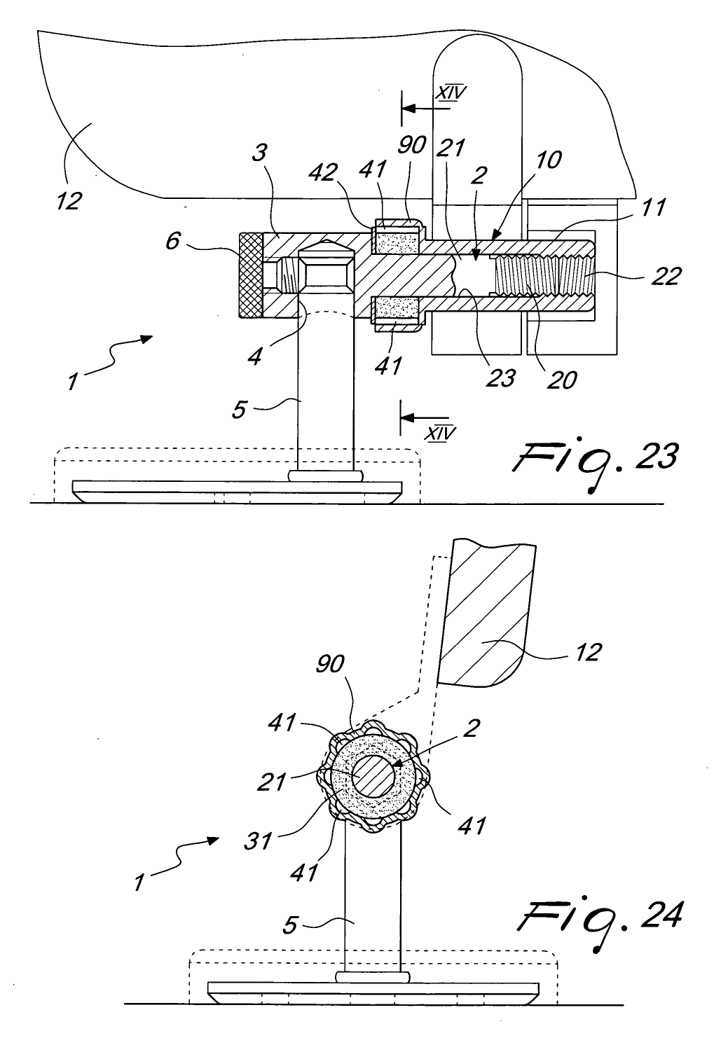

FIGS. 22 to 24 illustrate a ring 90, with peripheral protrusions, rigidly coupled to the bush 11 which constitutes the second body; it is optionally also possible to provide a washer, again designated by the reference numeral 42, which can be interposed between the elastically deformable body 31 and the base from which the stem 21 of the first body 2 protrudes.

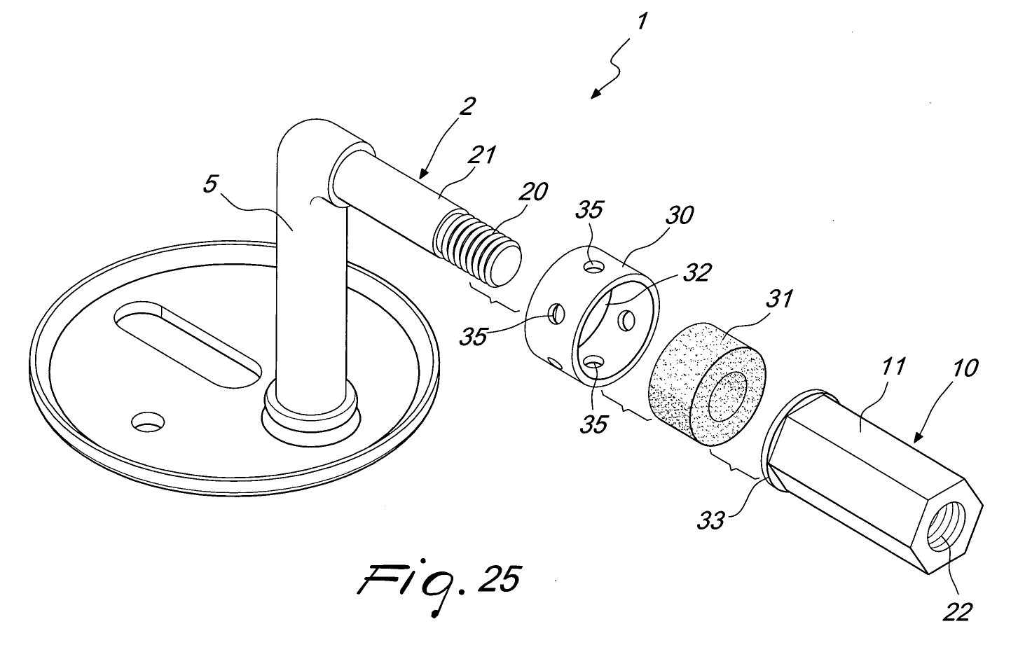

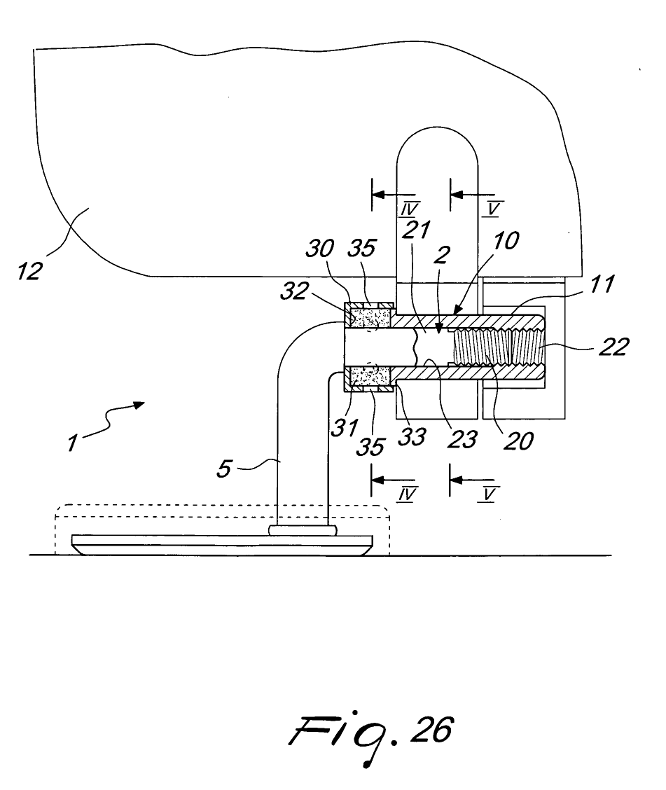

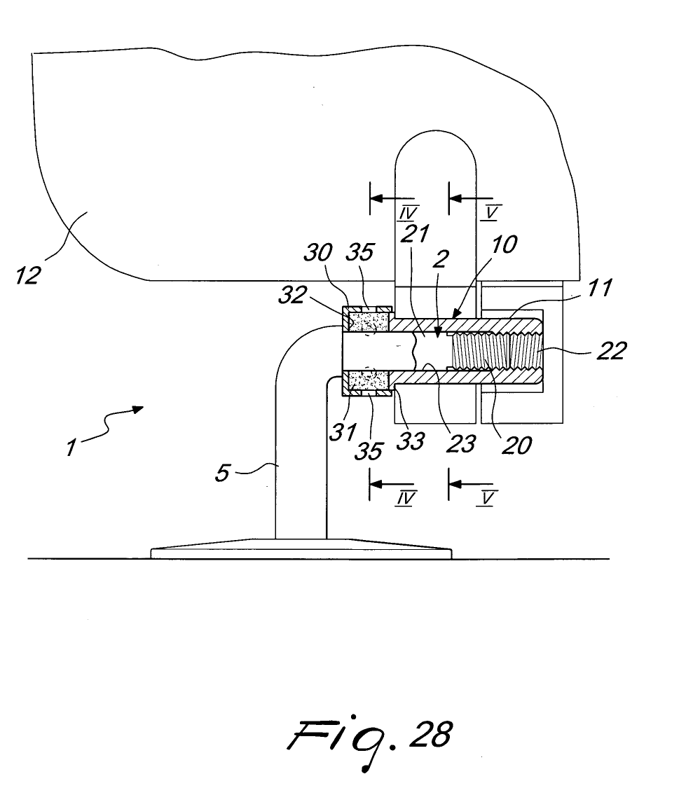

FIGS. 25 to 28 illustrate an embodiment which is similar to the one shown in FIGS. 1 to 6, with a different embodiment of the means for fixing to the sanitary fixture.

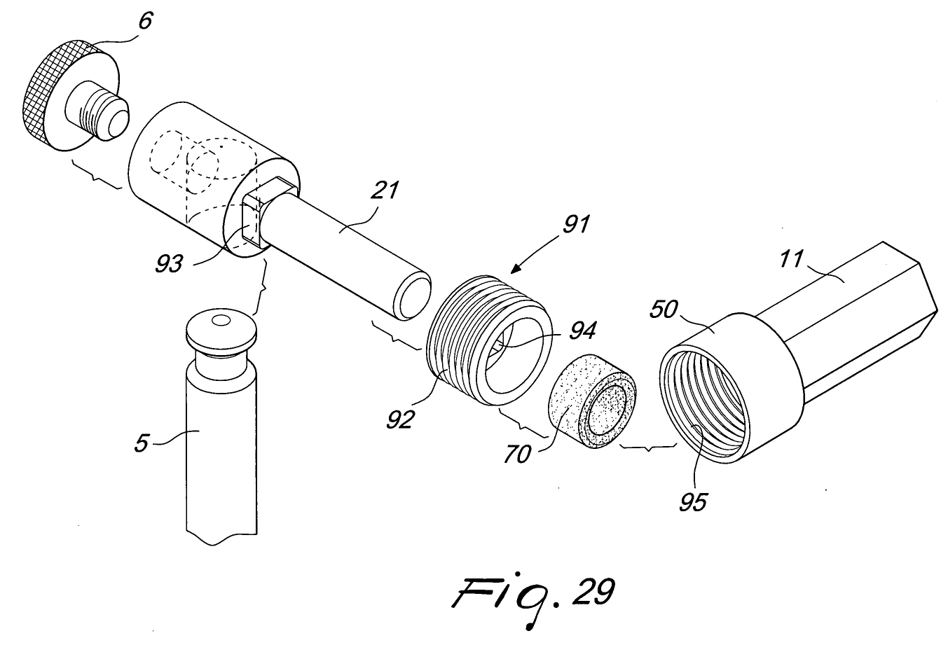

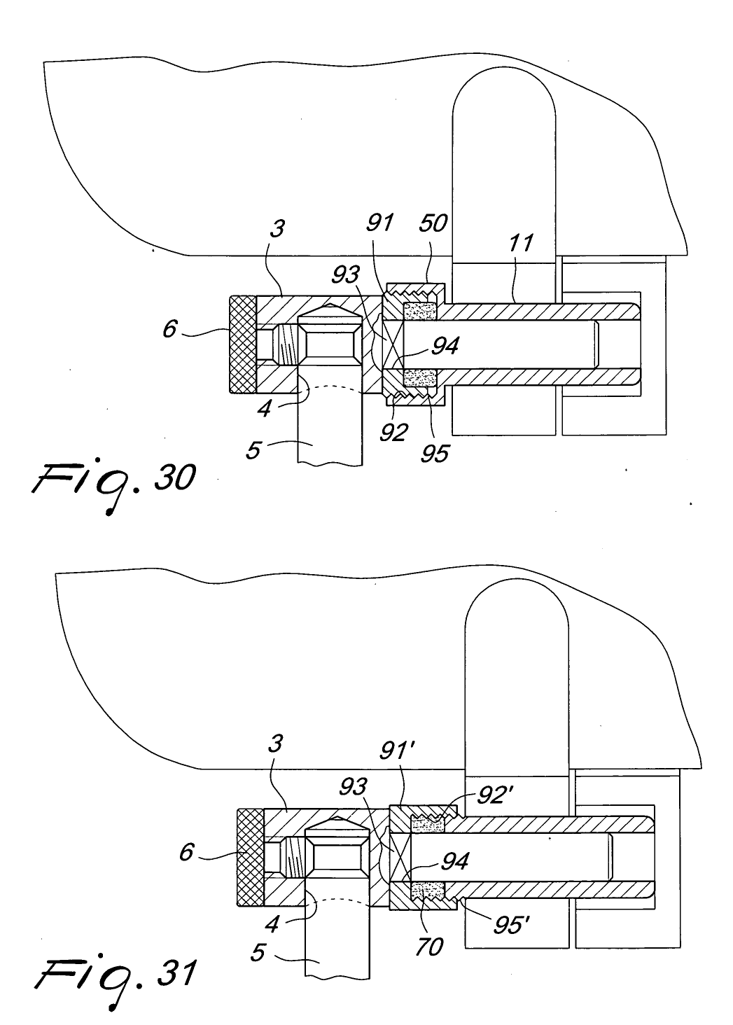

With reference to FIGS. 29 and 30, the means for translational motion are constituted by the external thread 92, defined by a threaded bush 91, which rotates rigidly with the stem 21 by means of the engagement of a rotation-preventing portion 93, which is for example polygonal and is defined by the stem 21, with a rotation-preventing seat 94 defined by the threaded bush 91.

The internal thread 95 defined at one end of the bush 11, at the fixed ring 50, engages the external thread 92.

The body 31 or 70 made of elastically deformable material can be accommodated inside the bush 91 and in practice can be clamped between the bottom of the ring 50 and the bottom of the threaded bush 91.

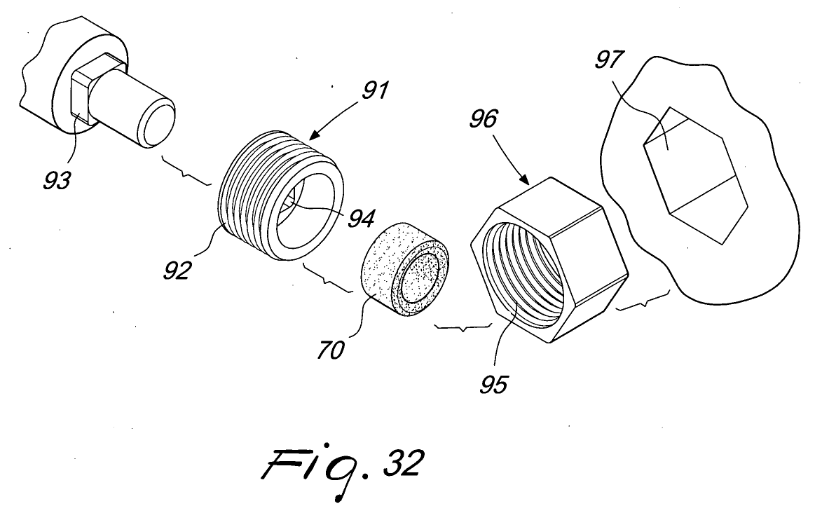

FIG. 31 illustrates a conceptually similar solution, in which there is an internally threaded bush 91′ which has an internal threaded portion 92′ which engages an external threaded portion 95′ which is connected to the bush 11.

In the embodiments shown in FIGS. 29 to 31, operation is similar, with a mutual translational motion between the bushes 91 and 11 or 91′ and 11 upon rotation between the first element and the second element.

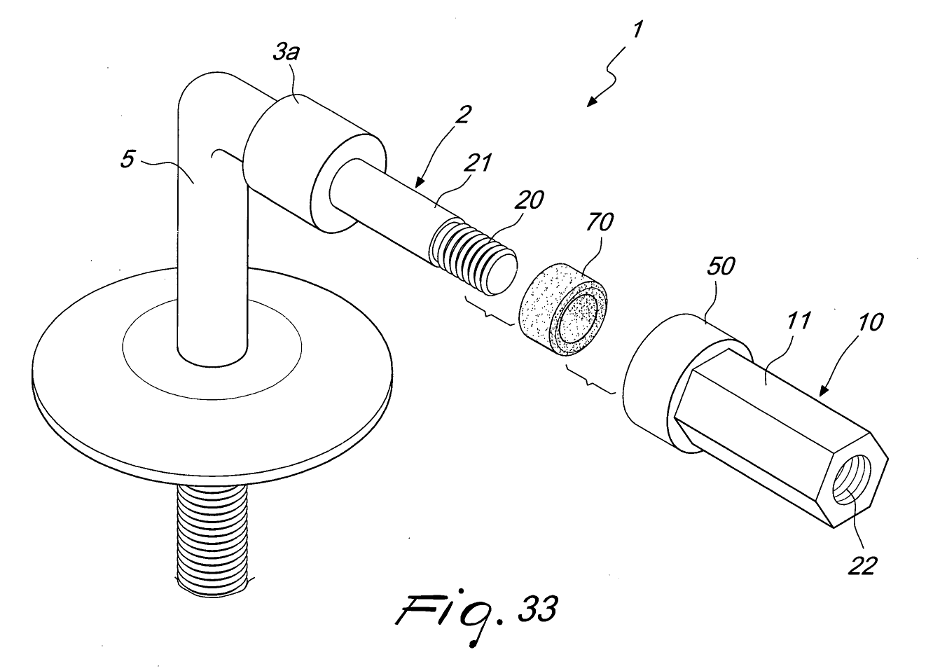

FIG. 32 illustrates an embodiment in which the internal thread 95 of a polygonal bush 96 mates with the threaded bush 91, which rotates rigidly with the first body, the polygonal bush 96 being insertable, so as to rotate rigidly therewith, in a polygonal seat 97 defined within the second body.

It should be specified that the bush 91 might be provided monolithically with the first body.

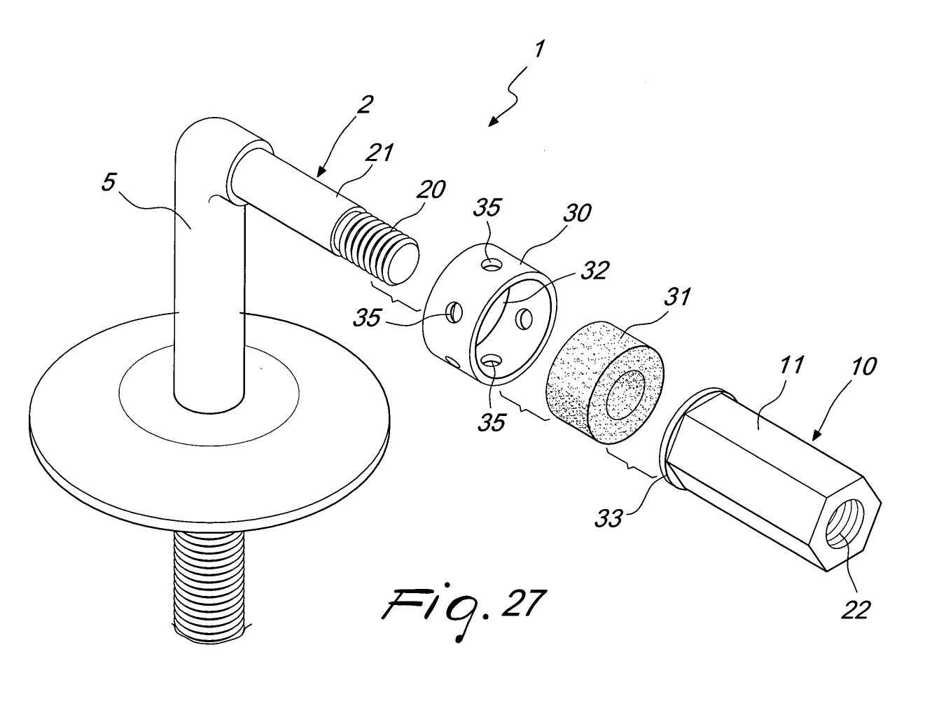

FIG. 33 illustrates an embodiment with the means for fixing to the sanitary fixture of the type shown in FIG. 27, in which there is an expansion 3a which is conceptually similar to the coupling body 3 and acts as an abutment for the elastically deformable body 70, which can be positioned inside the fixed ring 50 which is connected directly to the bush 11 which provides the second body 10.

The expansion 3a can be provided monolithically with the post 5 or connected like a washer, which can be able to rotate or rotationally locked.

From what has been described above it is therefore evident that the invention achieves the proposed aim and objects, and in particular the fact is stressed that a braking device is provided which, in order to apply the braking action, employs the axial compression of an elastically deformable element, which can be constituted by a mass of elastically flexible synthetic material, by a conveniently shaped spring or by any other element which, in order to undergo axial contraction, contrasts the movement in an axial direction of the second body, which in order to rotate is necessarily subjected to an axial displacement with respect to the first body.

Such means for translational motion in an axial direction are provided in a simple manner by mating a male thread and a female thread, but it is of course possible to provide other types of connection which allow to impose a translational motion to the second element when it is turned with respect to the first element.

In practice it is found that the invention achieves the proposed aim and objects, and in particular attention is called again to its extreme constructive simplicity.

The invention thus conceived is susceptible of numerous modifications and variations, all of which are within the scope of the appended claims.

All the details may further be replaced with other technically equivalent elements.

In the exemplary embodiments described, individual characteristics, given in relation to specific examples, may actually be interchanged with other different characteristics that exist in other exemplary embodiments.

In practice, the materials used, as well as the shapes or the dimensions of the contingent shapes, may be any according to requirements.

The disclosures in Italian Patent Application No. MI2007A001193 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-17. (canceled)

18. A braking device interposable between mutually rotatable elements, comprising a first body, which rotates rigidly with a first element, and a second body, which rotates rigidly with a second element and can engage rotatably said first body, comprising means for translational motion in order to impart a translational motion of said second body with respect to said first body upon mutual rotation, elastically deformable means being further provided which interact between said first body and said second body in order to contrast said translational motion upon mutual rotation between said bodies, at least in one preset direction.

19. The braking device according to claim 18, wherein said first body is connected to a coupling body which defines a seat in which it is possible to insert the contoured head of a pin which can be fixed to said first element.

20. The braking device according to claim 18, wherein said second body comprises a bush with an outer surface which can engage said second element so as to rotate rigidly therewith.

21. The braking device according to claim 20, wherein said means for translational motion comprise a threaded portion, which is defined by said first body and can engage in a threaded seat which is defined at a cavity formed within said bush.

22. The braking device according to claim 18, comprising a region for containing said elastically deformable means.

23. The braking device according to claim 18, wherein said region for containing said elastically deformable means has at least one region for the expansion of said elastically deformable means for their compression in an axial direction with respect to said first element.

24. The braking device according to claim 23, comprising a ring which is associated with said first body and delimits said containment region.

25. The braking device according to claim 24, wherein said elastically deformable means comprise a body made of elastically flexible material which is accommodated within said ring and can be engaged between a base flange of said ring and a front flange defined by said second body.

26. The braking device according to claim 24, wherein said expansion region is provided by openings defined in the side wall of said ring.

27. The braking device according to claim 24, wherein said expansion region is defined by radial protrusions of said ring.

28. The braking device according to claim 24, wherein said expansion region is defined by a peripheral protrusion provided on said ring.

29. The braking device according to claim 24, wherein said expansion region is defined by a peripheral hollow provided on said ring.

30. The braking device according to claim 24, wherein said expansion region is defined by said ring in cooperation with an elastically deformable body whose shape is contoured so as to leave regions which are free from said elastically deformable body within said ring.

31. The braking device according to claim 24, wherein said ring is rigidly associated with said second body.

32. The braking device according to claim 18, comprising a washer which can be interposed between said elastically deformable body and said second body.

33. The braking device according to claim 18, wherein said elastically deformable means can be precompressed in order to act as a retention element for said second element in any position of said second element.

34. A braking device for the covering element of a sanitary fixture, comprising a first body which rotates rigidly with a sanitary fixture and a second body which rotates rigidly with a covering element and can engage rotatably said first body, comprising means for translational motion, in order to impart a translational motion of said second body with respect to said first body upon mutual rotation, elastically deformable means being further provided which interact between said first body and said second body in order to contrast said translational motion upon mutual rotation between said bodies at least in one preset direction.
